(19) United States
(12) Patent Application Publication
(10) Pub. No.: US 2008/0141294 A1
(43) Pub. Date: Jun. 12, 2008

(54) Method and System for Managing Access to a Video Communication Device

(75) Inventors: Mark P. Leichter, Jamison, PA (US); Steven M. Mensoff, Blue Bell, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/609,552

(22) Filed: Dec. 12, 2006

(51) Int. Cl. H04N 7/16

(52) U.S. Cl. 725/28

(57) ABSTRACT

A method and system for managing access to a video communication device (102) is provided. The method comprises receiving (304) a communication request for one or more communication services. The method also comprises associating (306) the requested one or more communication services with at least one communication service identifier. Further, the method comprises identifying (308) the user (108) of the video communication device. Furthermore, the method comprises determining (310) whether the identified user is authorized to participate in the one or more requested communication services associated with the communication request. The video communication device comprises a receiver (202) that is adapted to receive a request for one or more communication services. The video communication device also comprises a memory (204) for storing a plurality of user identities. Further, the video communication device comprises a processor (206) that is adapted to compare the user identity the plurality of user identities.

### FIELD OF THE INVENTION

The present invention generally relates to the field of video communication, and more particularly, to a method and system for managing access to a video communication device.

### BACKGROUND OF THE INVENTION

Today, communication devices such as mobile phones are widely used for communicating with other communication devices present in a communication network. These communication devices use one or more communication services to communicate with other communication devices. Examples of such communication services include an incoming call service, an outgoing call service, a text messaging service, a network video message playback service, an outgoing video message recording service and the like. Examples of the communication devices include video communication devices, mobile phones, and the like. A video communication device can communicate with other communication devices by using a video message service and a video display service. For example, a user of a video communication device can communicate with a user of another video communication device in the communication network through video messages or a video call. The video communication device can use the one or more communication services to communicate with a communication device. For example, a user of a video communication device can communicate with another user of a communication device by initiating a call, by receiving a call, or by sending text messages. The user of the video communication device can be an authorized or an unauthorized user. The authorized user can restrict the unauthorized user from accessing some of the communication services provided by the video communication device.

The authorized user of the video communication device may not want the unauthorized user to access the video communication device. In some cases, the authorized user of the video communication device might want to restrict the unauthorized user from accessing a particular communication service. For example, a parent, who is an authorized user, might not want his/her child, who is an unauthorized user, to view certain video messages stored in the video communication device. Moreover, the parent might not want his/her child to make a video call or respond to a call from another communication device, to prevent the child being seen by the user of the other communication device.

Currently, there are methods available that restrict an unauthorized user from accessing other communication services. One of these methods involves the use of parental control in routers. A router is a networking device that acts as a junction between multiple networks and facilitates the transfer of data among the multiple networks. The collection of networks and routers is referred to as the Internet. This method provides a parental control system that can be used in routers. This parental control system stores a list of blocked Internet sites, as well as a list of blocked services pertaining to the unauthorized user. The parental control system restricts access to Internet sites present in the list of blocked Internet sites, as well as to the services present in the list of blocked services relating to the unauthorized user, by controlling the routers.

Another method for restricting an unauthorized user from accessing a communication service involves the Television V-Chip, which enables the authorized user to control access to a television program. The authorized user may select the control menu from the main menu to enter a password. After entering the password, he/she can lock programs by channel, by rating, and by time. As a result, the authorized user can allow the unauthorized user to access only those programs with ratings below a pre-defined limit or a channel that is not locked.

However, the methods explained above have one or more limitations. One of the methods prevents access to those Internet sites and services that are present in the list of blocked Internet sites and blocked services. The Internet sites and services are not blocked selectively for different unauthorized users but are blocked for all the unauthorized users. Another method provides unauthorized users with access to only those television programs that have been accorded an acceptable content rating or only to those channels that have not been locked by the authorized user. The channels are not locked selectively for different unauthorized users.

### BRIEF DESCRIPTION OF DRAWINGS

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an exemplary communication network, where various embodiments of the present invention can be practiced;

FIG. 2 is a block diagram of a video communication device, in accordance with an embodiment of the present invention;

FIG. 3 is a flow diagram illustrating a method for managing access to a video communication device, in accordance with an embodiment of the present invention; and

FIG. 4 and 5 is a flow diagram illustrating a method for managing access to a video communication device, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

For one embodiment, a method for managing access to a video communication device is provided. The method comprises receiving a communication request for one or more communication services. The method also comprises associating the requested one or more communication services with at least one communication service identifier. Further, the method comprises identifying the user of the video communication device. Furthermore, the method comprises determining whether the identified user is authorized to access one or more of the communication services associated with the communication request. The authorization of the identified user depends on at least one associated communication service identifier and a stored list of one or more communication services designated as enabled for the identified user.

For another embodiment, a video communication device is provided. The video communication device comprises a receiver that is adapted to receive a request for one or more communication services. At least one of the requested communication services is associated with at least one communication service identifier. The video communication device also comprises a memory for storing a plurality of user identities and an associated list of one or more communication services. Each of the plurality of user identities has an associated list of one or more communication services that are designated as enabled. The video communication device also comprises a processor that is operatively coupled to the receiver. The processor is adapted to identify the user of the video communication device and also to compare the user identity with the stored plurality of user identities, to determine if the one or more requested communication services are enabled for the identified user.

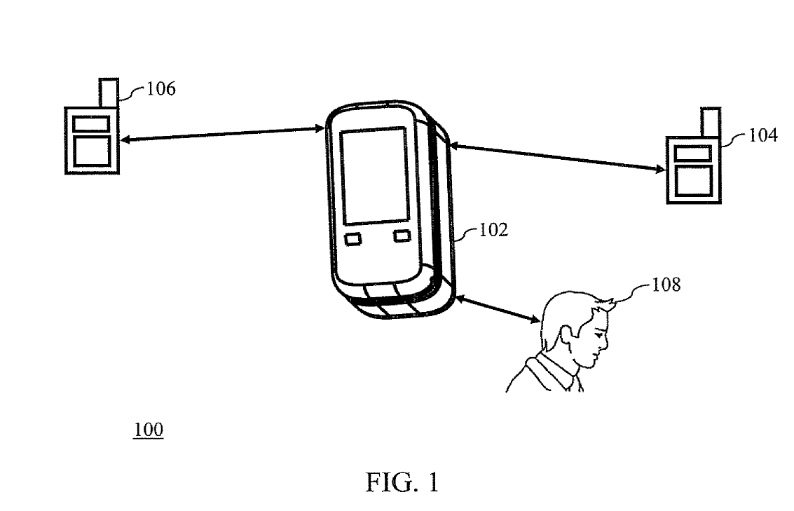

FIG. 1 illustrates a communication network 100, where various embodiments of the present invention can be practiced.

The communication network 100 comprises a video communication device 102 and a video communication device 104. The communication network 100 also comprises a communication device 106. For an embodiment, the video communication device 102 is a video mobile phone that is capable of using communication services such as a video display service, a video message service, an incoming call service, an outgoing call service, a network video message playback service and an outgoing video message recording. An example of the communication device 106 can be a mobile phone that is capable of using communication services such as an incoming call service and an outgoing call service.

The video communication devices 102 and 104 and the communication device 106 can communicate with each other in the communication network 100. For example, the video communication device 102 can communicate with the video communication device 104 by sending video messages, initiating a call, receiving a call or using a video display service. The video communication device 102 can communicate with the communication device 106 by sending text messages, or initiating or receiving a call. Although the video communication device 102 is shown to communicate only with the video communication device 104 and the communication device 106 in FIG. 1, it will be apparent to a person skilled in the art that the video communication device 102 can communicate with one or more video communication devices and one or more communication devices.

The video communication device 102 can be accessed by a user 108. In an embodiment, the user 108 can be an unauthorized user. The video communication device 102 can communicate with the video communication device 104 in the communication network 100 by using one or more communication services. Examples of the one or more communication services include a video display service, a video message service, an incoming call service, an outgoing call service, a network video message playback service, an outgoing video message recording service, and the like. The video communication device 102 can also communicate with the communication device 106 by using multiple communication services. Examples of such communications services include, but are not limited to, incoming calls and outgoing calls.

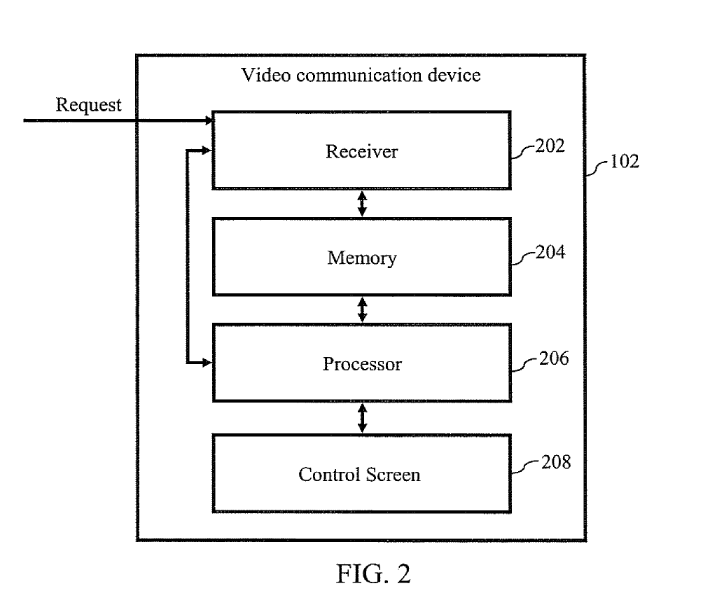

FIG. 2 is a block diagram of the video communication device 102, in accordance with an embodiment of the present invention. Examples of the communication services provided by the video communication device 102 include, but are not limited to, a video display service, a video message service, an incoming call service, an outgoing call service, a network video message playback and an outgoing video message recording.

The video communication device 102 comprises a receiver 202, a memory 204, and a processor 206. The receiver 202 can receive a request for accessing one or more communication services from the user 108. For example, the receiver 202 can receive a request from the user 108 to access the video message service. The one or more communication services are associated with a communication service identifier. Examples of the communication service identifier are a phone number of the communication device 106, an identification number of the communication device 106 in the communication network 100, a name assigned to the communication device 106 and the like. The memory 204 is operatively coupled to the receiver 202 and can store multiple user identities and an associated list of one or more communication services. Each user identity of the multiple user identities has an associated user who is capable of accessing the video communication device 102. Each user identity of the multiple user identities has an associated list of one or more communication services that are designated as enabled for the user identity. As a result, the user 108 can access only those communication services that are designated as enabled for the user identity in the associated list of one or more communication services. For example, the user 108 can access the video message service when the service is designated as enabled in his/her associated list.

The processor 206 is operatively coupled to the receiver 202 and can identify the user 108 of the video communication device 102. The processor 206 can also compare the identity of the user 108 with the multiple user identities, to determine the one or more requested communication services that are designated as enabled for the user identity. For an embodiment, the processor 206 provides the identified user 108 with access to the one or more communication services designated as enabled for the identified user 108. The identified user 108 refers to the user 108 when the user 108 has been identified by the processor 206. For example, when the incoming and outgoing call services are designated as enabled for the identified user 108 in the associated list, the identified user 108 can initiate a call and receive a call as well. In another embodiment, the processor 206 permits a user other then the identified user 108, to manage the associated list of one or more communication services that are designated as enabled for each of the multiple user identities. The user other than the identified user 108 is an authorized user of the video communication device 102 and can restrict the identified user 108 from accessing some communication services. The user other than the identified user 108 does this by not designating the communication services as enabled in the associated list of the identified user 108. For example, when the user other than the identified user 108 enables only the incoming call service and the outgoing call service in the associated list of the identified user 108, the identified user 108 can access only the incoming call service and the outgoing call service.

In yet another embodiment, the processor 206 determines the identity of the user 108 by comparing a code entered by the user 108 with an authorized code. An example of the code includes a Personal Identification Number (PIN), a password, and the like. In an embodiment, the processor 206 determines the identity of the user 108 by using a biometric sensor. The identity of the user 108 can also be determined by using a finger print recognition system, a retinal scan system and an RF key fob. In another embodiment, the processor 206 restricts the identified user 108 from accessing the one or more communication services that are not designated as enabled for the identified user 108. For an embodiment, the video communication device 102 also comprises a control screen 208, which acts as an interface between the user other than the identified user 108 and the processor 206. The control screen 208 can be used to manage the associated list of the one or more communication services designated as enabled for each of the multiple user identities. For example, the user other than the identified user 108 can select the identity of the user 108 from the multiple user identities by using the control screen 208. The user other than the identified user 108 can then enable the video message service in the associated list of the identified user 108 by selecting the video message service, using the control screen 208.

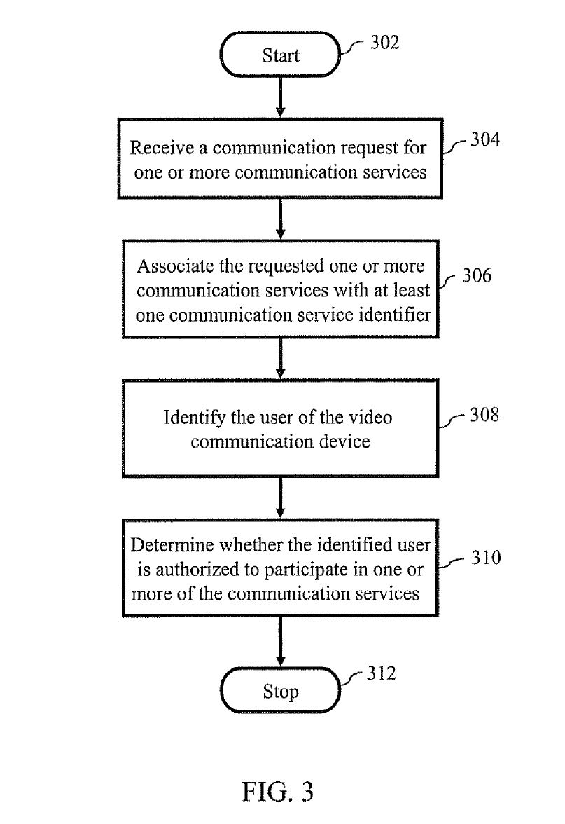

FIG. 3 is a flow diagram illustrating a method for managing access to a video communication device, in accordance with an embodiment of the present invention. To describe the method, reference will be made to FIG. 1, although it is understood that the method can be implemented with reference to any other suitable embodiment of the present invention.

At step 302, the method for managing access to a video communication device is initiated. At step 304, a request for accessing one or more communication services is received. For example, a request for accessing the incoming call service is received by the video communication device 102 from the user 108.

At step 306, the one or more communication services for which the request is received are associated with a communication service identifier. Examples of the communication service identifier are a phone number of the communication device 106, an identification number of the communication device 106 in the communication network 100, a name assigned to the communication device 106 and the like. At step 308, the user 108 of the video communication device 102 is identified. In an embodiment, the user 108 of the video communication device 102 is identified by comparing a code entered by the user 108 with an authorized code. In another embodiment, the user 108 of the video communication device 102 is identified by using a biometric sensor.

At step 310, authorization of the identified user 108 to participate in the one or more communication services is determined by comparing the identity of the user 108 with the multiple user identities. The authorization of the identified user 108 to participate in the one or more communication services depends on an associated communication service identifier and an associated list of one or more communication services. For each user identity of the multiple user identities, there is an associated list of one or more communication services that have been designated as enabled for the user identity. For example, when the incoming call service and the outgoing call service are designated as enabled in the associated list, the identified user 108 can initiate or receive a call. In an embodiment, the stored list of one or more communication services designated as enabled for the identified user 108 is managed by the user other than the identified user 108 and cannot be modified by the identified user 108. At step 312, the method is terminated.

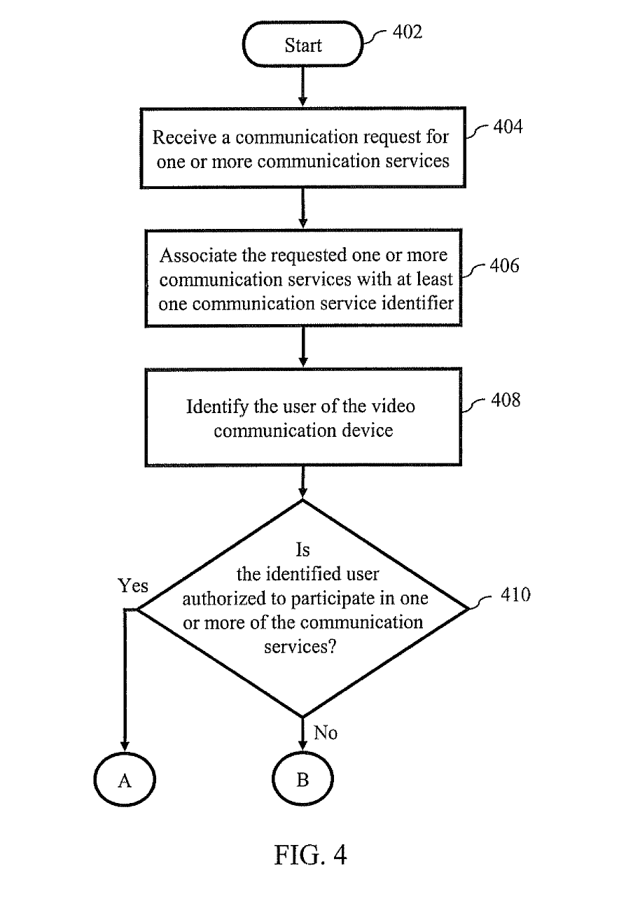

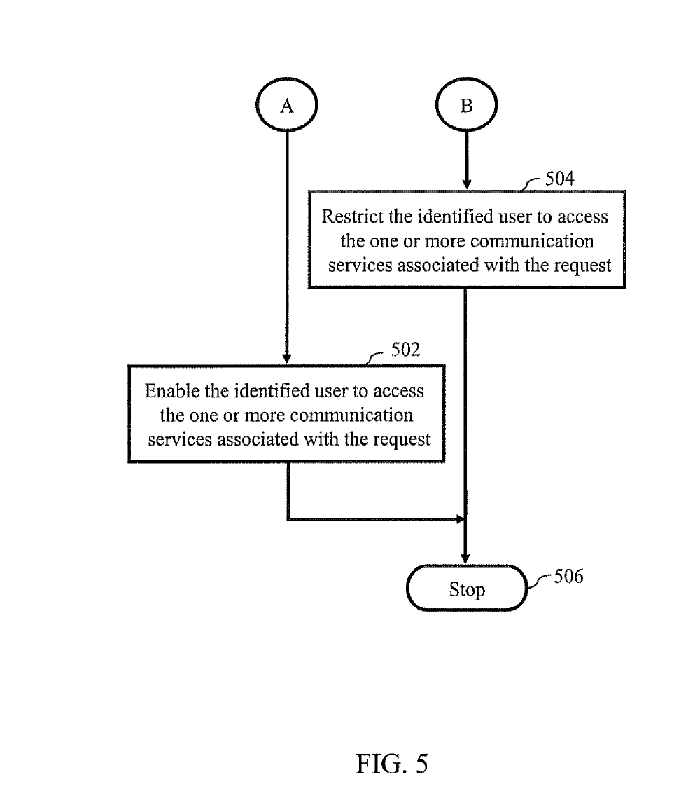

FIG. 4 and 5 is a flow diagram illustrating a method for managing access to a video communication device, in accordance with another embodiment of the present invention. To describe the method, reference will be made to FIG. 1, although it is understood that the method can be implemented in any other suitable embodiment of the present invention. Further, the method can have a greater or fewer numbers of steps than shown in FIG. 4 and 5.

At step 402, the method for managing access to a video communication device is initiated. At step 404, a request is received by the video communication device 102 from the user 108 to access one or more communication services provided by the video communication device 102. For example, a request for accessing an incoming call service is received by the video communication device 102 from the user 108 when the video communication device 102 receives a call from the communication device 106.

At step 406, the one or more communication services for which the request is received are associated with a communication service identifier. An example of the communication service identifier is a phone number of the communication device 106, an identification number of the communication device 106 in the communication network 100, a name assigned to the communication device 106 and the like. At step 408, the user 108 of the video communication device 102 is identified. In an embodiment, the user 108 of the video communication device 102 is identified by comparing a code entered by the user 108 with an authorized code. In another embodiment, the user 108 of the video communication device 102 is identified by using a biometric sensor.

At step 410, it is determined whether the identified user 108 is authorized to participate in the one or more communication services by comparing the identity of the user 108 with the multiple user identities. The authorization of the identified user 108 to participate in the one or more communication services depends on an associated communication service identifier and an associated list of one or more communication services. For each user identity of the multiple user identities there is an associated list of one or more communication services that are designated as enabled for the user identity. For example, when the incoming and outgoing call services are designated as enabled in the associated list for the identified user 108, the identified user 108 can initiate a call and also receive one. In an embodiment, the stored list of the one or more communication services designated as enabled for the identified user 108 is managed by the user other than the identified user 108. The stored list of one or more communication services designated as enabled cannot be modified by the identified user 108.

At step 502, the identified user 108 is enabled to access the one or more communication services associated with the request when the requested communication services are designated as enabled for the identified user 108 in the associated list. At step 504, the identified user 108 is restricted and is unable to access the one or more communication services associated with the request when the requested communication service is not designated as enabled for the identified user 108 in the associated list. At step 506, the method is terminated.

The video communication device 102 receives a request from the user 108 to access video messages. After receiving the request, the video communication device 102 identifies the identity of the user 108. Further, the video communication device 102 determines whether the video message service is enabled for the identified user 108. When the video message service is enabled for the identified user 108, the video communication device 102 provides the user 108 with access to the video message service. If the video message service is not enabled for the identified user 108, the video communication device 102 restricts the user 108 from accessing the video message service.

As described above, the present invention provides a method and system for managing access to a video communication device. The method restricts the access of an unauthorized user to one or more communication services, based on an associated list of one or more communication services that have been designated as enabled for the unauthorized user. The associated list for the unauthorized user is managed by an authorized user of the video communication device. Therefore, the present invention enables the authorized user of the video communication device to restrict the access of the unauthorized user to one or more communication services. For example, a parent, who is an authorized user, might not want his/her child, who is an unauthorized user, to view video messages. By disabling the video message service in the associated list of his/her child identity, the parent can restrict the child from accessing the video messages. The parent might not also want his/her child to make video calls. By disabling the video display service in the associated list of the child's identity, the parent can restrict the child from using the video display service. Thus, with the help of the present invention, a parent can restrict his/her child's access to certain communication services.

In the foregoing specification, the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method for managing access to a video communication device, comprising:
receiving a communication request for one or more communication services;
associating the requested one or more communication services with at least one communication service identifier;
identifying the user of the video communication device; and
determining whether the identified user is authorized to participate in one or more of the communication services associated with the communication request as a function of the at least one associated communication service identifier and a stored list of one or more communication services designated as enabled for the identified user.

2. The method as recited in claim 1 further comprising:
enabling the identified user to access the one or more communication services associated with the request when the requested communication service is designated as enabled for the identified user in the stored list.

3. The method as recited in claim 1, wherein the one or more communication services comprise a video display service.

4. The method as recited in claim 1, wherein the one or more communication services comprise a video message service.

5. The method of claim 1, wherein the stored list of one or more communication services designated as enabled for the identified user is managed by a user other than the identified user and cannot be modified by the identified user.

6. The method as recited in claim 1, wherein identifying the user comprises determining the identity of the user by comparing a code entered by the user with an authorized code.

7. The method as recited in claim 1, wherein identifying the user comprises determining the identity of the user using a biometric sensor.

8. The method as recited in claim 1 further comprising:
restricting the identified user from accessing the one or more communication services associated with the request when the requested communication service is not designated as enabled for the identified user in the stored list.

9. The method as recited in claim 8, wherein the requested one or more communication services comprises receiving an incoming communication at the video communication device.

10. The method as recited in claim 8, wherein the requested one or more communication services comprises initiating an outgoing communication from the video communication device.

11. A video communication device comprising:
a receiver adapted to receive a request for one or more communication services wherein at least one of the requested communication services is associated with at least one communication service identifier;
a memory storing a plurality of user identities and associated listings of one or more communication services designated as enabled for each of the plurality of user identities; and
a processor operatively coupled to the receiver, wherein the processor is adapted to identify the user of the video communication device, and to compare the user identity to the stored plurality of user identities list to determine if the one or more requested communication services are enabled for the identified user.

12. The video communication device as recited in claim 11, wherein the processor provides the identified user with access to the one or more communication services if the listing associated with the identified user's identity stored in the memory indicates the requested communication services are enabled.

13. The video communication device as recited in claim 11, wherein the one or more communication services requested comprise a video display service.

14. The video communication device as recited in claim 11, wherein the one or more communication services requested comprise a video message service.

15. The video communication device as recited in claim 11, wherein the processor is further adapted to permit a user other than the identified user manage the associated listings of one or more communication services designated as enabled for each of the plurality of user identities.

16. The video communication device as recited in claim 15, further comprising a control screen adapted for managing the associated listings of one or more communication services designated as enabled for each of the plurality of user identities.

17. The video communication device as recited in claim 11, wherein the processor is further adapted to determine the identity of the user by comparing a code entered by the user with an authorized code.

18. The video communication device as recited in claim 11, wherein the processor is further adapted to determine the identity of the user using a biometric sensor.

19. The video communication device as recited in claim 11, wherein the processor restricts the identified user from accessing to the one or more communication services if the listing associated with the identified user's identity stored in the memory does not indicate the requested communication services are enabled.
